(19) United States
(12) Patent Application Publication
(10) Pub. No.: US 2018/0095679 A1
(43) Pub. Date: Apr. 5, 2018

(54) DEVICE DRIVER TO PROVIDE REDUNDANT ARRAY OF INDEPENDENT DISKS FUNCTIONALITY

(71) Applicants: Piotr Wysocki, Gdansk (PL); Lukasz Lasek, Skarzysko Kamienna (PL)

(72) Inventors: Piotr Wysocki, Gdansk (PL); Lukasz Lasek, Skarzysko Kamienna (PL)

(21) Appl. No.: 15/281,272

(22) Filed: Sep. 30, 2016

(51) Int. Cl. G06F 3/06

(52) U.S. Cl. CPC G06F 3/0619; G06F 3/0665; G06F 3/0689

(57) ABSTRACT

An electronic processing system may include a device driver to provide redundant array of independent disks (RAID) functionality. The device driver may include a detector to detect whether operation as a RAID controller device is established. The device driver may also include a controller to establish operation of a device as the RAID controller device when no device has established operation as the RAID controller device. The device driver may further include a publisher to publish a block device before exposure as usable storage, wherein publication of the block device is to be understood only by the RAID controller device.

### TECHNICAL FIELD

Embodiments generally relate to a device driver. More particularly, embodiments relate to a device driver that provides redundant array of independent disks (RAID) functionality.

### BACKGROUND

Bootable software RAID technologies may require a pre-Operating System (OS) driver with RAID logic, such as a Unified Extensible Firmware Interface (UEFI) driver or Option Read Only Memory (ROM), to be present at a basic input/output system (BIOS) image. The pre-OS driver may be loaded against a Peripheral Component Interconnect Express (PCIe) hardware controller card that aggregates drives which may be RAID member disks. For example, the pre-OS driver may be loaded against a Serial AT Attachment/Serial Attached Small Computer Interface (SATA/SAS) PCIe RAID controller card for SATA/SAS drives, against a Volume Management Device (VIVID) for Non-Volatile Memory Express (NVMe) drives or devices, etc. Collaboration, however, may be required from an original equipment manufacturer (OEM) to ensure that the pre-OS driver is sent to be included in the BIOS image. Moreover, it will not be possible to boot from RAID if there is no pre-OS driver present in the BIOS image or present on a hardware controller device.

### BRIEF DESCRIPTION OF THE DRAWINGS

The various advantages of the embodiments will become apparent to one skilled in the art by reading the following specification and appended claims, and by referencing the following drawings, in which:

FIGS. 1A to 1B are block diagrams of an example of an electronic processing system according to an embodiment;

FIG. 2 is a block diagram of an example of a device driver according to an embodiment;

FIGS. 3A to 3D are flowcharts of an example of a method to provide RAID functionality according to an embodiment;

FIG. 4 is a block diagram of an example of a computing system according to an embodiment.

### DESCRIPTION OF EMBODIMENTS

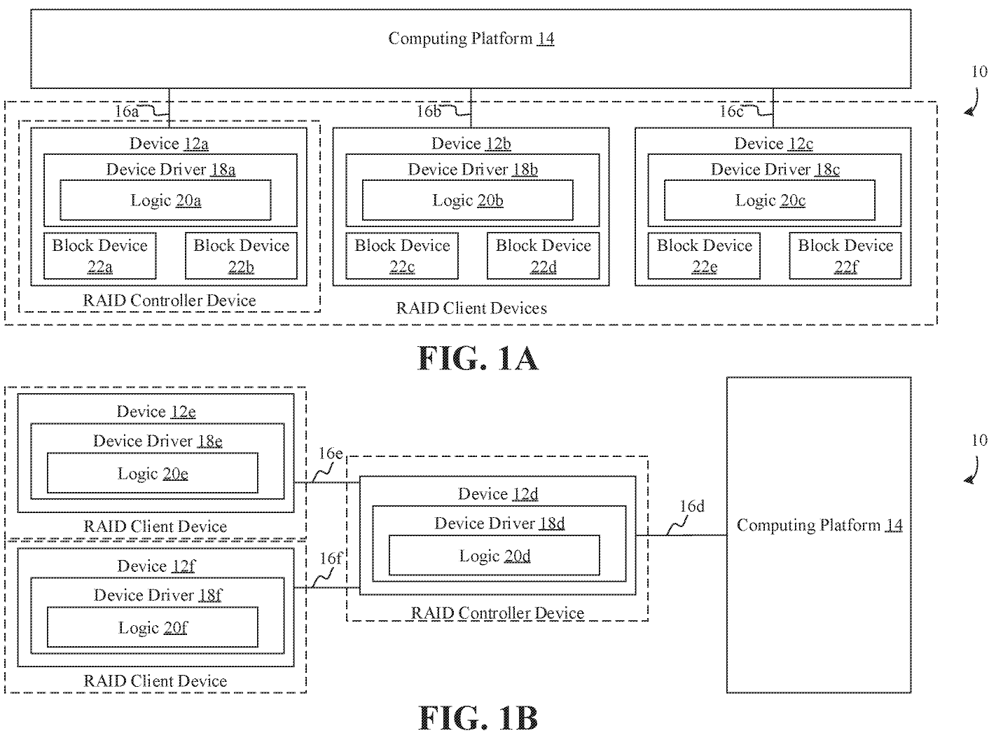

Turning now to FIG. 1A, an embodiment of an electronic processing system 10 may include devices 12 (12a-12c) coupled with a computing platform 14 via communication links 16 (16a-16c). In one example, the devices 12 of the electronic processing system 10 may include types of Peripheral Component Interconnect (PCI) Express (PCIe) devices (e.g., PCIe Base Specification, revision 3.1a, published in December 2015), including Non-Volatile Memory Express (NVMe) devices (e.g., NVMe Specification, revision 1.2a, published in October 2015), coupled via respective PCIe lanes to a processor (e.g., a central processing unit (CPU)), to a platform controller hub (PCH), and so on. In the illustrated example, the devices 12a-12c include device drivers 18 (18a-18c) to provide RAID functionality. Notably, the device drivers 18a-18c do not need to be present in the BIOS image of the electronic processing system 10. Moreover, the device drivers 18a-18c may dynamically negotiate amongst themselves to determine which device is to establish operation as a RAID controller device and which device is to establish operation as a RAID client device to provide RAID functionality (e.g., to manage and/or process input/output (I/O) operations for performance, storage, and/or redundancy).

The device drivers 18a-18c may include, for example, UEFI device drivers that are deployed as Option ROMs for respective types of PCIe devices (e.g., NVMe Option ROM UEFI driver). Details of the UEFI specification, such as the UEFI specification Version 2.4 (Errata B), are readily available by Unified UEFI, Inc. Thus, for example, the device drivers 18a-18c may be sequentially loaded one after another when the electronic processing system 10 powers up and starts a UEFI environment. In the illustrated example, the device drivers 18a-18c include logic 20 (20a-20c) (e.g., logic instructions, configurable logic, fixed-functionality logic hardware, etc., or any combination thereof) to provide RAID functionality.

If the device driver 18a is loaded first, the logic 20a may detect that no device has established operation as the RAID controller device and establishes that the device 12a is to operate as the RAID controller device (e.g., takes operation, claims operation, starts operation, etc.). For example, the logic 20a may identify whether a private control protocol is installed by any device in the UEFI environment, and installs the private control protocol to establish operation as the RAID controller device when the private control protocol has not been installed. The private control protocol may include a private GUID (e.g. 128-bit globally unique identifier for the protocol interface) and a set of functions (e.g., to access a device, etc.), wherein the presence of the private control protocol (e.g., GUID#1 protocol) may indicate that a device has established operation as the RAID controller device. GUID#1 may refer to a RAID service GUID.

In one example, the UEFI OpenProtocol( ) and CloseProtocol( ) boot services may be leveraged to track whether the private control protocol has been installed. For example, the UEFI OpenProtocolInformation function may be called to retrieve a list of agents that are currently consuming a protocol interface, the UEFI LocateProtocol function may be called to find the first handle in the handle database the supports the requested protocol, and so on. In addition, a database (e.g., a linked list, etc.) that is managed by firmware and that shows which protocols are attached to each device handle may be queried. Moreover, the UEFI InstallMultipleProtocolInterfaces function may be called to install one or more protocol interfaces onto a device handle, which may point to a list of one or more protocols that can respond to requests for services for a given device referred to by the handle. Thus, for example, the logic 20a may run the UEFI Start( ) function to check if a UEFI protocol with private GUID#1 has been installed, and installs the GUID#1 protocol to a device handle.

The logic 20a may also install and/or use a private publication protocol (e.g., GUID#2 protocol) having a private GUID (e.g., GUID#2) to publish a block device in the UEFI environment. GUID#2 may refer to a private I/O protocol's GUID. The private publication protocol may be compliant with UEFI BLOCK I/O PROTOCOL, which generally includes information that defines how to access a certain type of device during boot services and allows boot services code to perform block I/O without knowing the type of a device or its controller. In this regard, a device driver that is to be a storage device driver may publish the BLOCK_DEVICE_IO protocol to handle I/O's against the block device. BLOCK I/O protocol functions may include FlushBlocks( ) (e.g., cache flushed blocks), ReadBlocks( ) (e.g., read the requested number of blocks from the device), Reset( ) (e.g., reset the block device hardware), WriteBlocks( ) (e.g., write the requested number of blocks to the device), and so on.

When the device driver 18b is subsequently loaded, the logic 20b detects that a device has established operation as the RAID controller and establishes that the device 12b is to operate as a RAID client device. Similarly, the logic 20c establishes that the device 12c is to operate as a RAID client device when the device driver 18c is subsequently loaded. For example, the logic 20b, 20c may each identify that the private control protocol has been installed and, in response, establish that the devices 12b, 12c are to operate as RAID client devices that provide RAID functionality (e.g., participate in I/O operations) but that do not manage RAID functionality. In one example, the logic 20b, 20c may each run the UEFI Start( ) function to check if a UEFI protocol with private GUID#1 has been installed, and install and/or use the private publication protocol (e.g., GUID#2 protocol) to begin communication and may not install the GUID#1 protocol when the private GUID#1 protocol has already been installed by any device driver. In this regard, more than one device driver may install the GUID#1 protocol if device drivers are configured and/or willing to cooperate and negotiate which device driver will act as a driver for a RAID controller device.

The logic 20a-20c may further implement an administration operation and/or an I/O operation for the devices 12a-12c, respectively. For example, the devices 12a-12c include respective block devices 22 (22a-22f) such as, for example, namespaces (e.g., regions of NVMe devices, etc.), and the logic 20a-20c may enumerate (e.g., discover) namespaces, create new namespaces, read states (e.g., normal state, degraded state, etc.), and so on. In addition, the logic 20a-20c may process I/O operations such as read, write, flush, reset, and so on. Thus, the logic 20a-20c may be device-specific in charge of communicating with a specific type of device and all block devices corresponding to the specific type of device (e.g., located at the device, coupled with the device, etc.) using a specific protocol for the specific type of storage device. For example, the logic 20a-20c may be included in an NVMe driver for an NVMe device.

The logic 20a may publish the block devices 22a-22b associated with the storage device 12a, the logic 20b may publish the block devices 22c-22d associated with the storage device 12b, and the logic 20c may publish the block devices 22e-22f associated with the storage device 12c. In this regard, the logic 20a may use an instance of the private publication protocol (e.g., GUID#2 protocol) to publish the block device 22a and use another instance of the private publication protocol to publish the block device 22b. Similarly, the logic 20b, 20c may each use two instances of the private publication protocol to publish the block devices 22c-22d and 22e-22f, respectively. Thus, there may be six private publication protocols with GUID#2 published in the UEFI environment that are understood and/or consumed by the RAID controller device.

The logic 20a may, for example, trigger and/or use a callback function when any new instance of the GUID#2 protocol is detected, which may augment an ability to evaluate or process configuration settings. In one example, the callback function may be called directly by the logic 20a. In another example, the callback function may be invoked autonomously by UEFI firmware. In this regard, UEFI protocol notifications may be utilized in autonomous invocations. The callback function may, for example, trigger identification of the block devices 22e-22df associated with the particular instance of the GUID#2 protocol and/or trigger exposure of the block devices 22e-22df associated with the particular instance of the GUID#2 protocol. The callback function may, for example, trigger a read of metadata corresponding to a storage device to discover candidate and/or potential RAID member disks. Thus, the logic 20a may identify whether the private publication protocol is used to publish the block devices 22e-22df, determine that one or more block devices 22e-22df is a member disk (e.g., read RAID metadata), and check whether a RAID volume is to be exposed. The RAID volume may be exposed when, for example, there are as many member disks detected to qualify the volume as being in normal or degraded state. Moreover, the logic 20a may determine that one or more of block devices 22e-22df are not a member disk (no RAID metadata), and may expose one or more of the block devices 22e-22df as a pass-through device.

The logic 20a may, for example, use a public protocol that includes a path to a volume storage device, such as one or more of the devices 12a-12c corresponding to the block devices 22a-22f In addition, the logic 20a may use a public protocol that includes a path to a pass-through device, such as one or more of the devices 12a-12c corresponding to the block devices 22a-22f For example, the logic 20a may use a generic UEFI BLOCK I/O PROTOCOL (and other protocols if necessary) with a UEFI Device Path that points to a device to be exposed (e.g., to a UEFI subsystem) as a volume member disk, that points to a device to be exposed as a pass-through device, and so on. Thus, the device path may be used to define the programmatic path to a device, which may include an NVMe namespace messaging device path, a SCSI device path, CD-ROM media device path, a hard drive media device path, and so on.

While the logic 20a-20c may be capable of managing RAID functionality, the device that establishes operation as the RAID controller device manages RAID functionality. In the illustrated example, the logic 20a may manage a RAID operation (e.g., an I/O operation) involving the block devices 22a-22f whether the devices 12a-12c are exposed as volume storage devices of a RAID volume or are exposed as pass-through devices. The logic 20a may, for example, pass I/O requests to the devices 12a-12c using the private publication protocol (e.g., GUID#2 protocol), which process the I/O requests. The logic 20a may further manage a RAID schema (e.g., RAID 0, RAID1, RAID2, RAID3, RAID4, RAID5, etc.). For example, the logic 20a may provide mirroring, striping, parity, creation of RAID levels, configuration of volumes, access to pass-through devices, and so on. Moreover, the logic 20a may manage communication with a user interface to manage RAID functionality. In one example, the logic 20a may communicate with a user interface that provides options to a user to configure the RAID functionality such as, for example, aspects as the RAID schema (e.g., parity enablement, etc.).

While embodiments may utilize aggregation hardware and/or drivers in a BIOS image that leverage private communication protocols to provide RAID functionality, embodiments may not require aggregation hardware to be present in a computing platform (e.g., VIVID) or a UEFI driver with RAID logic to be present in a BIOS image. Embodiments may provide bootable RAID solutions from any device, such as from NVMe devices. As illustrated in Table 1, a device (e.g., one or more NVMe devices, etc.) may be implemented with off-the-shelf computing platforms to provide RAID functionality without any hardware or software modifications to the off-the-shelf computing platform (e.g., via embedded RAID in NVMe Option ROM UEFI driver). Thus, it may be possible to manage block devices (e.g., manage RAID volumes, etc.) using driver-to-driver communication to dynamically provide RAID functionality (e.g., create/delete volumes using UEFI driver HII interface, install LINUX OS on a volume and boot OS from a RAID volume that in a normal or degraded state, etc.).

Table 1: RAID logic is introduced to a UEFI driver that is deployed as an Option ROM of a NVMe driver (a device with this driver may be referred to a “RAID Ready SSD”).

| | | Purley | | Avoton | |
|---|---|---|---|---|---|
| | | (with VMD | Greenlow | micro- | Core ™ |
| | Grantley | disabled) | refresh | server | i7 |
| RSTe RAID Ready | OK | OK | OK | OK | OK |
| UEFI driver visible | | | | | |
| in BIOS HII | | | | | |
| All RAID Ready | OK | OK | OK | OK | OK |
| drives visible | | | | | |
| Creating volume in | OK | OK | OK | OK | OK |
| RSTe RAID Ready | | | | | |
| UEFI driver HII, | | | | | |
| a volume is exposed | | | | | |
| properly in BIOS | | | | | |
| after restart | | | | | |
| Linux SLES 12 | OK | OK | OK | OK | OK |
| SP1 installation | | | | | |
| on a volume | | | | | |
| Boot Linux SLES 12 | OK | OK | OK | OK | OK |
| SP1 from volume in | | | | | |
| NORMAL state | | | | | |
| Boot Linux SLES 12 | OK | OK | OK | OK | OK |
| SP1 from volume in | | | | | |
| DEGRADED state | | | | | |
| Boot SLES Linux | OK | OK | OK | OK | OK |
| from volume in | | | | | |
| DEGRADED state | | | | | |
| with volume rebuild | | | | | |
| in progress | | | | | |

FIG. 1B shows an embodiment of the electronic processing system 10 that includes device 12d coupled with the computing platform 14 via a communication link 16d and devices 12e, 12f coupled with the computing platform 14 via respective communication links 16e, 16f via device 12d. Thus, the device 12d may include a hardware controller device, such as a Serial AT Attachment (SATA) controller card (e.g., SATA 3.2, published in February 2016), a Serial Attached Small Computer Interface (SAS) controller card (e.g., SAS-3, published March 2013), a Volume Management Device (VIVID), etc., which aggregates the devices 12e, 12f (e.g., SATA devices, SAS devices, NVMe devices, etc.) and is coupled via PCIe lane 16d to a processor (e.g., a central processing unit (CPU)), to a platform controller hub (PCH), and so on. The devices 12d-12f include device drivers 18d-18f having logic 20d-20f, respectively, which are similar to the device drivers 18a-18c having the logic 20a-20c (FIG. 1A), discussed above.

In the illustrated example, the device driver 18d will be loaded first and the logic 20d establishes that the device 12d is to operate as the RAID controller device. For example, the logic 20d may identify whether a private control protocol (e.g., GUID#1 protocol) is installed, and installs the private control protocol to establish operation as the RAID controller device if the private control protocol has not been installed by any device in the UEFI environment. When the device drivers 18e, 18f are subsequently loaded, the logic 20e, 20f detect that a device has established operation as the RAID controller device and establishes that the respective devices 12e, 12f are to operate as RAID client devices. For example, the logic 20e may identify that the private control protocol has been installed and establishes that the device 12e is to operate as a RAID client device.

The logic 20d-20f may further implement an administration operation and/or an I/O operation for the devices 12d-12f, respectively. For example, the devices 12e, 12f may themselves be block devices (e.g., SATA device, SAS device, etc.) or may include block devices (e.g., NVMe namespaces, etc.), and the logic 20d-20f may enumerate controllers, enumerate drives connected to a controller, enumerate namespaces, read states, and so on. Additionally, the logic 20e, 20f may process I/O operations such as read, write, flush, reset, and so on. Moreover, the logic 20e, 12f may publish block devices by, for example, using an instance of the private publication protocol (e.g., GUID#2 protocol) that may be understood and/or that may be consumed only by the RAID controller device.

The logic 20d may, for example, use a callback function to trigger identification of the devices 12e, 12f (e.g., as block devices) in response to identification of the private publication protocol (e.g., a new instance of GUID#2 protocol) used to publish the devices 12e, 12f. The callback function may, for example, trigger a read of metadata corresponding to a storage drive to discover candidate and/or potential RAID member disks. In one example, the logic 20d may determine that one or more of the devices 12e, 12f is a RAID member disk (e.g., via RAID metadata) and checks whether a RAID volume is to be exposed. If the RAID volume is to be exposed, the logic 20d may expose the devices 12e, 12f using a path to the devices 12e, 12f as volume storage devices. If the devices 12e, 12f are not RAID member disks, the logic 20d may expose the devices 12e, 12f using a path to the devices 12e, 12f as pass-through devices. Moreover, the logic 20d may manage RAID functionality, such as managing an I/O operation involving the devices 12e, 12f (e.g., whether as volume storage devices or pass-through devices), a RAID schema (e.g., R0-R5, etc.), communication with a user interface (e.g., GUI, etc.), and so on.

While examples have provided various components of the electronic processing system 10 for illustration purposes, it should be understood that one or more components of the electronic processing system 10 may reside in the same and/or different physical and/or virtual locations, may be combined, omitted, bypassed, re-arranged, and/or be utilized in any order. Moreover, any or all components of the electronic processing system 10 may be automatically implemented (e.g., without human intervention, etc.).

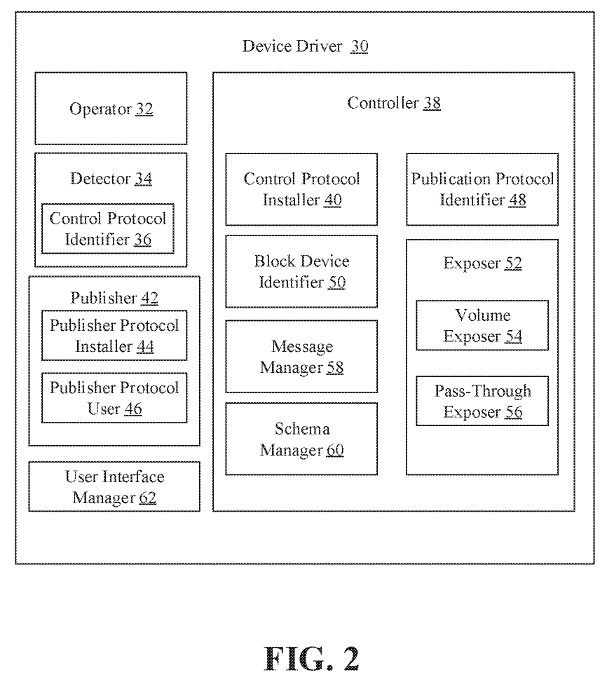

Turning now to FIG. 2, a device driver 30 to provide RAID functionality is shown according to an embodiment. The device driver 30 may be similar to any of the device drivers 18a-18f (FIGS. 1A to 1B), discussed above. Thus, the device driver 30 may correspond to a device driver for a storage device (e.g., a SATA device, a SAS device, an NVMe device), or to a hardware controller device (e.g., a SATA controller, a SAS controller, a VMD, etc.), and so on.

In the illustrated example, the device driver 30 includes an operator 32 to implement an operation for a device. The operator 32 may, for example, implement an administration operation such as enumerating namespaces (e.g., regions of NVMe devices, etc.), creating new namespaces, reading states (e.g., normal, degraded, etc.), enumerating controllers, enumerating drives connected to a controller, and so on. The operator 32 may also implement an I/O operation, such as processing an I/O read operation, an I/O write operation, and so on. Thus, the operator 32 may be device-specific to communicate with a specific type of device and all block devices associated with the specific type of device.

The device driver 30 further includes a detector 34 to detect whether operation as a RAID controller device is established. For example, the detector 34 may include a control protocol identifier 36 to identify whether a private control protocol (e.g., GUID#1 protocol) is installed. In one example, the control protocol identifier 36 may run the UEFI Start( ) function to check if a UEFI protocol with private GUID#1 has been installed. The device driver 30 further includes a controller 38 to establish operation of a device as the RAID controller device when no device has established operation as the RAID controller device. For example, the controller 38 may include a control protocol installer 40 to install the private control protocol to establish operation as the RAID controller device.

The control protocol installer 40 may install the GUID#1 protocol, for example, on any handle including a newly created handle (e.g., for this purpose). In one example, the control protocol installer 40 may install the GUID#1 protocol to a device handle when any device driver in a UEFI environment has not installed the GUID#1 protocol. In another example, the control protocol installer 40 may install the GUID#1 protocol to an image handle when any device in a UEFI environment has not installed the GUID#1 protocol. The presence of the private control protocol may indicate to other device drivers that a device has established operation as the RAID controller device. In addition, more than one device driver may install the GUID#1 protocol if the device drivers are configured and/or willing to cooperate and negotiate which device driver will act as a driver for a RAID controller device. In one example, the control protocol installer 40 may install the GUID#1 protocol to a device handle and/or to an image handle, and negotiate what device driver will operate as a driver for a RAID controller device when other device drivers have installed the GUID#1 protocol.

The device driver 30 further includes a publisher 42 to publish a block device before exposure of the block device as usable storage in the UEFI environment, wherein only the RAID controller device may understand publication of the block device. For example, the publisher 42 may include a publication protocol installer 44 to install a private publication protocol (e.g., GUID#2 protocol) to publish a block device in the UEFI environment. Moreover, the publisher 42 includes a publication protocol user 46 to publish the block device using the private publication protocol, wherein publication using the private publication protocol is understood and/or consumed only by the RAID controller device. Thus, the controller 38 may include a publication protocol identifier 48 to identify whether the private publication protocol is used.

The controller 38 further includes a block device identifier 50 to identify the block device. For example, the block device identifier 50 may trigger and/or use a callback function to trigger an identification of the block device (e.g., that is discovered and published) in response to identification of the private publication protocol used to publish the block device. The block device identifier 50 may, for example, trigger and/or use a callback function when any new instance of the GUID#2 protocol is detected, which may trigger a read of metadata corresponding to a storage drive to discover candidate and/or potential RAID member disks. The callback function may be invoked autonomously by UEFI firmware. In this regard, UEFI protocol notifications may be utilized in autonomous invocations.

In addition, the controller 38 includes an exposer 52 to expose the block device as useable storage in a RAID operation (e.g., an I/O read, etc.). The exposer 52 may determine that a block device is a RAID member disk (e.g., via RAID metadata) and checks whether a RAID volume is to be exposed. For example, a RAID volume may be exposed when there are as many member disks detected to qualify the volume as being in normal or degraded state. If the RAID volume is to be exposed, a volume exposer 54 exposes the RAID volume. If the block device is not a member disk (e.g., no RAID metadata), a pass-through exposer 56 may expose the block device as a pass-through device.

The volume exposer 54 may, for example, use a public protocol that is to include a path to a volume storage device corresponding to the block device. For example, the volume exposer 54 may use a generic UEFI BLOCK I/O PROTOCOL (and other protocols if necessary) with a UEFI Device Path that points to a device exposed as a volume storage device, such as a type of PCIe device (e.g., NVMe device, etc.). Moreover, the pass-through exposer 56 may expose a pass-through device using a public protocol that is to include a path to the pass-through device where the block device is located. The pass-through exposer 56 may use a generic UEFI BLOCK I/O PROTOCOL (and other protocols if necessary) with a UEFI Device Path that points to a device, such as a type of PCIe device (e.g., NVMe device, etc.), where a namespace is located.

The controller 38 further includes a message manager 58 to pass I/O requests to volume storage devices, to pass-through devices, and so on. In one example, the message manager 58 may use the private publication protocol (e.g., GUID#2 protocol) to pass the I/O requests to the volume storage devices and/or to the pass-through devices, which process the I/O requests. Moreover, the controller 38 includes a schema manager 60 to manage a RAID schema. For example, the schema manager 60 may provide mirroring, striping, parity, creation of RAID levels, configuration of volumes, designation of pass-through devices, and so on.

The device driver 30 further includes a user interface manager 62 to communicate with a user interface that provides options to a user to manage one or more of the components of the device driver 30. For example, the user interface manager may communicate with a graphical user interface to manage the schema manager 60 to provide the RAID schema (e.g., volume configuration, parity enablement, etc.). The user interface may include, for example, a user interface of a development tool application, of a boot service, of a UEFI application, and so on. Thus, the user interface may include a graphical user interface, a command line interface, an auditory interface, a tactile interface, and so on.

While examples have provided various components of the device driver 30 for illustration purposes, it should be understood that one or more components of the device driver 30 may reside in the same and/or different physical and/or virtual locations, may be combined, omitted, bypassed, re-arranged, and/or be utilized in any order. Also, any or all components of the device driver 30 may be automatically implemented (e.g., without human intervention, etc.).

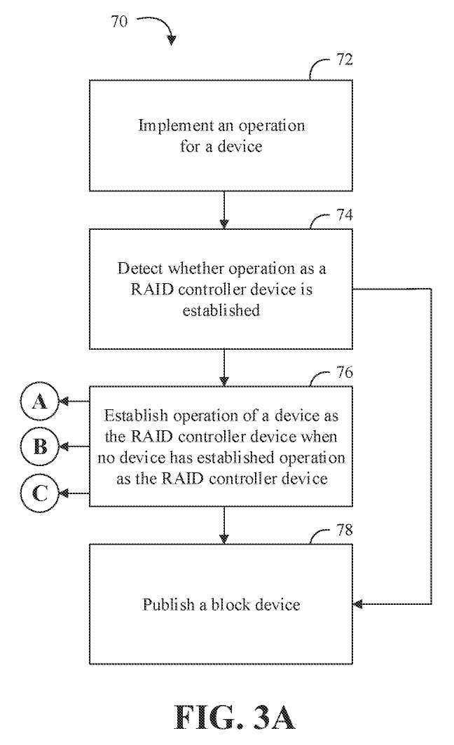

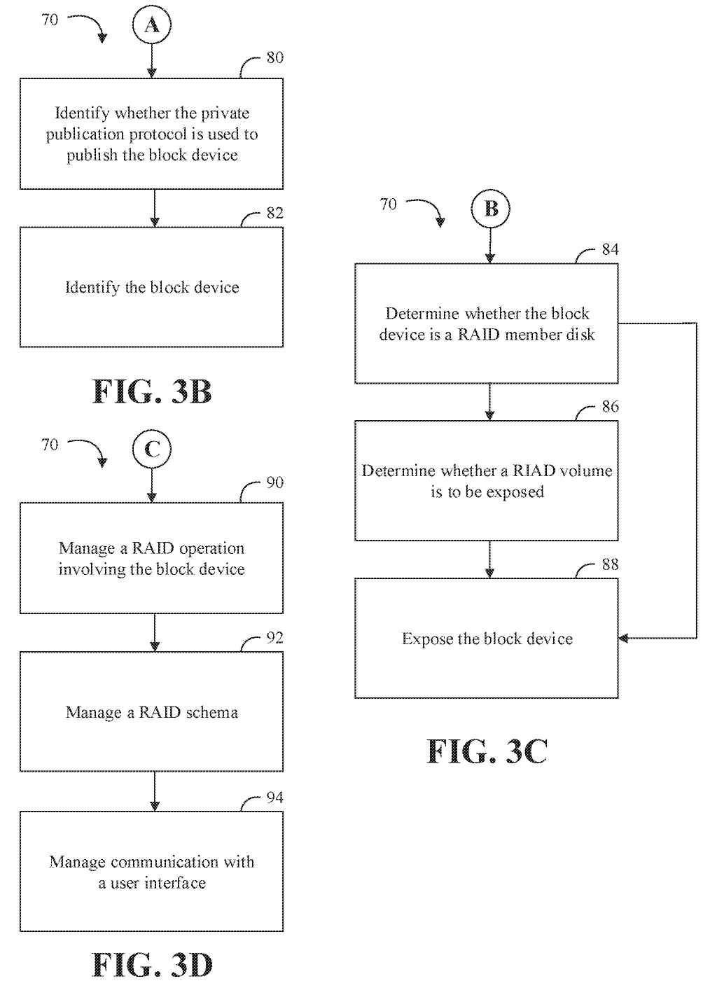

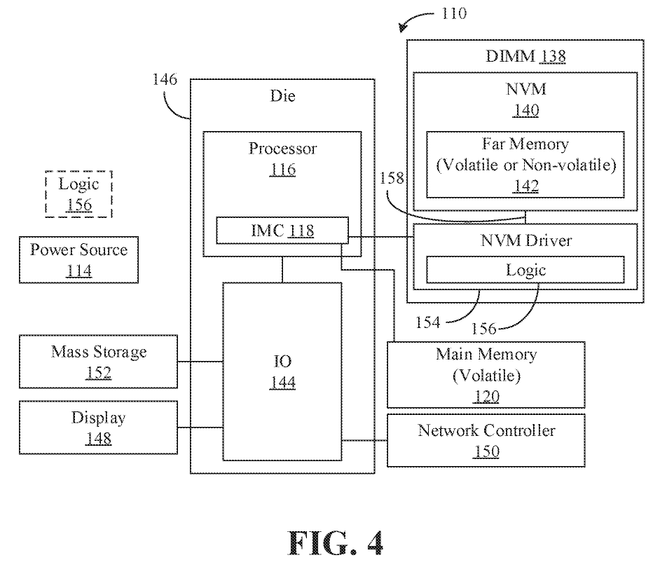

FIGS. 3A to 3D show an embodiment of a method 70 to provide RAID functionality. The method 70 may generally be implemented in an electronic processing system such as, for example, the electronic processing system 10 (FIGS. 1A to 1B), already discussed, in a device driver such as, for example, the device driver 30 (FIG. 2), already discussed, and so on. More particularly, the method 70 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 70 may be written in any combination of one or more operating system applicable/appropriate programming languages, including an object oriented programming language such as JAVA, SMALLTALK, C++ or the like and conventional procedural programming languages, such as the “C” programming language or similar programming languages. The method 70 may be implemented by, for example, UEFI FW/OpROM dispatcher executed by a host.

Illustrated processing block 72 implements an operation for a device. For example, block 72 may implement an administration operation such as enumerating namespaces (e.g., regions of NVMe devices, etc.), creating new namespaces, reading states (e.g., normal, degraded, etc.), enumerating controllers, enumerating devices connected to a controller, and so on. Block 72 may also implement an I/O operation, such as an I/O read operation, an I/O write operation, an I/O flush operation, an I/O reset operation, and so on. Block 72 may be device-specific, to communicate with a specific type of device and all block devices associated with the specific type of device.

Illustrated processing block 74 detects whether operation as a RAID controller device is established. For example, block 74 may identify whether a private control protocol (e.g., GUID#1 protocol) is installed. In one example, block 74 may run the UEFI Start( ) function to check if a UEFI protocol with private GUID#1 has been installed. Illustrated processing block 76 establishes operation of a device as the RAID controller device when no device has established operation as the RAID controller device. For example, block 76 may install a private control protocol (e.g., GUID#1 protocol) to establish operation as the RAID controller device. Thus, block 76 may install the GUID#1 protocol to a handle (e.g., an image handle, a device handle) when any device in a UEFI environment has not installed the GUID #1 protocol. Block 76 may also, for example, install the GUID#1 protocol to a handle if the GUID#1 protocol is already installed (e.g., at another device) and/or there is an ability and/or a willingness to cooperate and negotiate establishment as the RAID controller device.

Illustrated processing block 78 publishes a block device. For example, block 78 may publish a block device before exposure of the block device as usable storage in the UEFI environment. Block 78 may, for example, install a private publication protocol (e.g., GUID#2 protocol) to publish a block device in the UEFI environment. Moreover, block 78 may publish the block device using the private publication protocol, wherein publication using the private publication protocol is understood and/or consumed only by the RAID controller device.

Illustrated processing block 80 identifies whether the private publication protocol is used to publish the block device. For example, block 80 may detect a new instance of GUID#2 protocol. Illustrated processing block 82 identifies the block device. For example, block 82 may trigger and/or use a callback function to trigger an identification of the block device (e.g., that is discovered and published) in response to identification of the private publication protocol. Block 82 may, for example, trigger and/or use a callback function when any new instance of the GUID#2 protocol is detected to identify the block device, which may trigger a read of metadata corresponding to a storage device to discover candidate and/or potential RAID member disks. The callback function may be invoked autonomously by UEFI firmware. In this regard, UEFI protocol notifications may be utilized in autonomous invocations.

Illustrated processing block 84 determines whether the block device is a RAID member disk. Block 84 may, for example, read RAID metadata corresponding to a storage device to determine if the block device is a RAID member disk of a RAID volume. If the block device is a RAID member disk, illustrated processing block 86 determines whether a RIAD volume is to be exposed. A RAID volume may be exposed when there are as many member devices detected to qualify the volume as being in normal or degraded state. If the RAID volume is to be exposed, illustrated processing block 88 may expose the RAID volume (e.g., to a UEFI subsystem) to expose the block device.

For example, block 88 may use a generic UEFI BLOCK I/O PROTOCOL (and other protocols if necessary) with a UEFI Device Path that points to a device as a volume storage device, such as a type of PCIe device (e.g., NVMe device, etc.). If the block device is not a RAID member disk (e.g., no RAID metadata), block 88 may expose the block device as a pass-through device. For example, block 88 may use a generic UEFI BLOCK I/O PROTOCOL (and other protocols if necessary) with a UEFI Device Path that points to a device as a pass-through device, such as a type of PCIe device (e.g., NVMe device, etc.), where a namespace is located. Thus, for example, client devices may use a private protocol to pass their real Device Path (along with Block IO and Disk Identify) to a RAID controller, which may use this information to install a Device Path appropriate either for PassThrough or RAID device. For RAID, the RAID controller may select a Device Path from one of the member disks but it may also construct any other Device Path, based on private information. If client devices were to install a public Device Path on their Device Handles, the RAID controller the Device Path would not be unique and the RAID controller may not be able to manage such devices.

Illustrated processing block 90 manages a RAID operation involving the block device. For example, block 90 may pass I/O requests to the block device, which process the I/O requests. In one example, block 90 may pass I/O requests using the private publication protocol (e.g., GUID#2 protocol). Illustrated processing block 92 manages a RAID schema. Block 92 may, for example, provide mirroring, striping, parity, creation of RAID levels, configuration of volumes, designation of pass-through devices, and so on. Illustrated processing block 94 manages communication with a user interface to manage RAID functionality. For example, block 94 may communicate with a user interface that provides options to a user to manage the RAID functionality such as, for example, aspects of a RAID schema.

While independent blocks and/or a particular order has been shown for illustration purposes, it should be understood that one or more of the blocks of the method 70 may be combined, omitted, bypassed, re-arranged, and/or flow in any order. Moreover, any or all blocks of the method 70 may be automatically implemented (e.g., without human intervention, etc.).

Turning now to FIG. 4, a computing system 110 may provide RAID functionality according to an embodiment. The computing system 110 may generally be part of an electronic device/platform having computing functionality (e.g., datacenter, server, personal digital assistant/PDA, notebook computer, tablet computer), communications functionality (e.g., smart phone), imaging functionality, media playing functionality (e.g., smart television/TV), wearable functionality (e.g., watch, eyewear, headwear, footwear, jewelry), vehicular functionality (e.g., car, truck, motorcycle), etc., or any combination thereof. In the illustrated example, the system 112 includes a power source 114 to supply power to the system 110 and a processor 116 having an integrated memory controller (IMC) 118 that is coupled to main memory 120 (e.g., volatile “near” memory). The IMC 118 may also be coupled to another memory module 138 (e.g., dual inline memory module/DIMM) containing a non-volatile memory structure such as, for example, NVM 140. The NVM 140 may include “far” memory 142, which may also be used to store volatile data. Thus, the far memory 142 and the main memory 120 may function as a two-level memory (2LM) structure, wherein the main memory 120 generally serves as a low-latency and high-bandwidth cache of the far memory 142.

The NVM 140 may include any non-volatile memory device such as, for example, 3-dimensional cross-point memory that uses chalcogenide phase change material, flash memory, ferroelectric memory, silicon-oxide-nitride-oxide-silicon (SONOS) memory, polymer memory, ferroelectric polymer memory, ferroelectric transistor random access memory (FeTRAM or FeRAM), ovonic memory, nanowire, electrically erasable programmable read-only memory (EEPROM), phase change memory, memristors or spin transfer torque—magnetoresistive random access memory (STT-MRAM), and so on. As already noted, the memory module 138 may include volatile memory, for example, DRAM configured as one or more memory modules such as, for example, DIMMs, small outline DIMMs (SODIMMs), etc. Examples volatile memory include dynamic volatile memory includes DRAM (dynamic random access memory), or some variant such as synchronous DRAM (SDRAM).

A memory subsystem as described herein may be compatible with a number of memory technologies, such as DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (LPDDR version 5, currently in discussion by JEDEC), HBM2 (HBM version 2, currently in discussion by JEDEC), and/or others, and technologies based on derivatives or extensions of such specifications.

The illustrated system 112 also includes an input output (IO) module 144 implemented together with the processor 116 on a semiconductor die 146 as a system on chip (SoC), wherein the IO module 144 functions as a host device and may communicate with, for example, a display 148 (e.g., touch screen, liquid crystal display/LCD, light emitting diode/LED display), a network controller 150, and mass storage 152 (e.g., hard disk drive/HDD, optical disk, flash memory, etc.). The memory module 138 may include an NVM driver 154 having logic 156 that is connected to the far memory 142 via an internal bus 158 or other suitable interface. The illustrated logic 156 may implement one or more aspects of the device drivers 18a-18f (FIGS. 1A to 1B), one or more aspects of the device driver 30 (FIG. 2), and/or one or more aspects of the method 70 (FIGS. 3A to 3D), already discussed. The logic 156 may alternatively be implemented elsewhere in the system 110.

### Additional Notes and Examples

Example 1 may include an apparatus to provide redundant array of independent disks (RAID) functionality comprising logic, implemented at least partly in one or more of a configurable logic or fixed functionality logic hardware, to implement a device driver for a storage device, the device driver to include a detector to detect whether operation as a RAID controller device is established, a controller to establish operation of a device as the RAID controller device when no device has established operation as the RAID controller device, and a publisher to publish a block device before exposure as usable storage, wherein publication of the block device is to be understood only by the RAID controller device.

Example 2 may include the apparatus of Example 1, the device driver further including an operator to implement an administration operation and an input/output (I/O) operation, wherein the operator is to be device-specific to communicate with a specific type of device and all block devices associated with the specific type of device.

Example 3 may include the apparatus of any one of Examples 1 to 2, further including the logic to implement two or more instances of the device driver that are each to be deployed as an option ROM of a NVMe driver.

Example 4 may include the apparatus of any one of Examples 1 to 3, the device driver further including an exposer to expose the block device as useable storage in a RAID operation.

Example 5 may include the apparatus of any one of Examples 1 to 4, the device driver further including a volume exposer to expose a RAID volume using a public protocol that is to include a path to a volume storage device corresponding to the block device, and a pass-through exposer to expose a pass-through device using a public protocol that is to include a path to the pass-through device where the block device is located.

Example 6 may include the apparatus of any one of Examples 1 to 5, the device driver further including a message manager to use a private publication protocol to pass an input/output (I/O) request to one or more of a volume storage device or a pass-through device, and a schema manager to manage a RAID schema.

Example 7 may include the apparatus of any one of Examples 1 to 6, the device driver further including a control protocol installer to install the private control protocol to establish operation as the RAID controller device, and a publication protocol user to publish the block device using a private publication protocol, wherein publication using the private publication protocol is to be understood only by the RAID controller device.

Example 8 may include the apparatus of any one of Examples 1 to 7, the device driver further including, a publication protocol identifier to identify whether the private publication protocol is used to publish the block device, and a block device identifier to identify the block device in response to identification of the private publication protocol.

Example 9 may include at least one computer readable storage medium comprising a set of instructions, which when executed by a processor, cause the processor to, detect whether operation as a redundant array of independent disks (RAID) controller device is established, establish operation of a device as the RAID controller device when no device has established operation as the RAID controller device, and publish a block device before exposure as usable storage, wherein publication of the block device is to be understood only by the RAID controller device.

Example 10 may include the at least one computer readable storage medium of Example 9, wherein the instructions, when executed, cause the processor to implement an administration operation and an input/output (I/O) operation, wherein the device is to be device-specific to communicate with a specific type of device and all block devices associated with the specific type of device.

Example 11 may include the at least one computer readable storage medium of any one of Examples 9 to 10, further including two or more instances of a device driver that are each to be deployed as an option ROM of a NVMe driver.

Example 12 may include the at least one computer readable storage medium of any one of Examples 9 to 11, wherein the instructions, when executed, cause the processor to expose the block device as useable storage in a RAID operation.

Example 13 may include the at least one computer readable storage medium of any one of Examples 9 to 12, wherein the instructions, when executed, cause the processor to expose a RAID volume using a public protocol that is to include a path to a volume storage device corresponding to the block device, and expose a pass-through device using a public protocol that is to include a path to the pass-through device where the block device is located.

Example 14 may include the at least one computer readable storage medium of any one of Examples 9 to 13, wherein the instructions, when executed, cause the processor to use a private publication protocol to pass an input/output I/O request to one or more of a volume storage device or a pass-through device, and manage a RAID schema.

Example 15 may include the at least one computer readable storage medium of any one of Examples 9 to 14, wherein the instructions, when executed, cause the processor to install the private control protocol to establish operation as the RAID controller device, and publish the block device using a private publication protocol, wherein publication using the private publication protocol is to be understood only by the RAID controller device.

Example 16 may include the at least one computer readable storage medium of any one of Examples 9 to 15, wherein the instructions, when executed, cause the processor to identify whether the private publication protocol is used to publish the block device, and identify the block device in response to identification of the private publication protocol.

Example 17 may include a method to provide redundant array of independent disks (RAID) functionality comprising detecting whether operation as a redundant array of independent disk (RAID) controller device is established, establishing operation of a device as the RAID controller device when no device has established operation as the RAID controller device, and publishing a block device before exposure as usable storage, wherein publication of the block device is understood only by the RAID controller device.

Example 18 may include the method of Example 17, further including implementing an administration operation and an input/output (I/O) operation, wherein the device is device-specific to communicate with a specific type of device and all block devices associated with the specific type of device.

Example 19 may include the method of any one of Examples 17 to 18, further including two or more instances of a device driver that are each to be deployed as an option ROM of a NVMe driver.

Example 20 may include the method of any one of Examples 17 to 19, further including exposing the block device as useable storage in a RAID operation.

Example 21 may include the method of any one of Examples 17 to 20, further including exposing a RAID volume using a public protocol that includes a path to a volume storage device corresponding to the block device, and exposing a pass-through device using a public protocol that includes a path to the pass-through device where the block device is located.

Example 22 may include the method of any one of Examples 17 to 21, further including using a private publication protocol to pass an input/output (I/O) request to one or more of a volume storage device or a pass-through device, and managing a RAID schema.

Example 23 may include the method of any one of Examples 17 to 22, further including installing the private control protocol to establish operation as the RAID controller device, and publishing the block device using a private publication protocol, wherein publication using the private publication protocol is understood only by the RAID controller device.

Example 24 may include the method of any one of Examples 17 to 23, further including identifying whether the private publication protocol is used to publish the block device, and identifying the block device in response to identification of the private publication protocol.

Example 25 may include an apparatus to provide redundant array of independent disks (RAID) functionality comprising means for performing the method of any one of Examples 17 to 24.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated. The various blocks described in connection with flow diagrams do not imply an order of operation unless explicitly stated.

As used in this application and in the claims, a list of items joined by the term “one or more of” or “at least one of” may mean any combination of the listed terms. For example, the phrases “one or more of A, B or C” may mean A; B; C; A and B; A and C; B and C; or A, B and C. In addition, a list of items joined by the term “and so on” or “etc.” may mean any combination of the listed terms as well any combination with other terms.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An apparatus to provide redundant array of independent disks (RAID) functionality comprising:
logic, implemented at least partly in one or more of a configurable logic or fixed functionality logic hardware, to implement a device driver for a storage device, the device driver to include:
a detector to detect whether operation as a RAID controller device is established;
a controller to establish operation of a device as the RAID controller device when no device has established operation as the RAID controller device; and
a publisher to publish a block device before exposure as usable storage, wherein publication of the block device is to be understood only by the RAID controller device.

2. The apparatus of claim 1, the device driver further including an operator to implement an administration operation and an input/output (I/O) operation, wherein the operator is to be device-specific to communicate with a specific type of device and all block devices associated with the specific type of device.

3. The apparatus of claim 1, further including the logic to implement two or more instances of the device driver that are each to be deployed as an option ROM of a NVMe driver.

4. The apparatus of claim 1, the device driver further including an exposer to expose the block device as useable storage in a RAID operation.

5. The apparatus of claim 4, the device driver further including:
a volume exposer to expose a RAID volume using a public protocol that is to include a path to a volume storage device corresponding to the block device; and
a pass-through exposer to expose a pass-through device using a public protocol that is to include a path to the pass-through device where the block device is located.

6. The apparatus of claim 1, the device driver further including:
a message manager to use a private publication protocol to pass an input/output (I/O) request to one or more of a volume storage device or a pass-through device; and
a schema manager to manage a RAID schema.

7. The apparatus of claim 1, the device driver further including:
a control protocol installer to install the private control protocol to establish operation as the RAID controller device; and
a publication protocol user to publish the block device using a private publication protocol, wherein publication using the private publication protocol is to be understood only by the RAID controller device.

8. The apparatus of claim 7, the device driver further including:
a publication protocol identifier to identify whether the private publication protocol is used to publish the block device; and
a block device identifier to identify the block device in response to identification of the private publication protocol.

9. At least one computer readable storage medium comprising a set of instructions, which when executed by a processor, cause the processor to:
detect whether operation as a redundant array of independent disks (RAID) controller device is established;
establish operation of a device as the RAID controller device when no device has established operation as the RAID controller device; and
publish a block device before exposure as usable storage, wherein publication of the block device is to be understood only by the RAID controller device.

10. The at least one computer readable storage medium of claim 9, wherein the instructions, when executed, cause the processor to implement an administration operation and an input/output (I/O) operation, wherein the device is to be device-specific to communicate with a specific type of device and all block devices associated with the specific type of device.

11. The at least one computer readable storage medium of claim 9, further including two or more instances of a device driver that are each to be deployed as an option ROM of a NVMe driver.

12. The at least one computer readable storage medium of claim 9, wherein the instructions, when executed, cause the processor to expose the block device as useable storage in a RAID operation.

13. The at least one computer readable storage medium of claim 12, wherein the instructions, when executed, cause the processor to:
expose a RAID volume using a public protocol that is to include a path to a volume storage device corresponding to the block device; and
expose a pass-through device using a public protocol that is to include a path to the pass-through device where the block device is located.

14. The at least one computer readable storage medium of claim 9, wherein the instructions, when executed, cause the processor to:
use a private publication protocol to pass an input/output I/O request to one or more of a volume storage device or a pass-through device; and
manage a RAID schema.

15. The at least one computer readable storage medium of claim 9, wherein the instructions, when executed, cause the processor to:
install the private control protocol to establish operation as the RAID controller device; and
publish the block device using a private publication protocol, wherein publication using the private publication protocol is to be understood only by the RAID controller device.

16. The at least one computer readable storage medium of claim 15, wherein the instructions, when executed, cause the processor to:
identify whether the private publication protocol is used to publish the block device; and
identify the block device in response to identification of the private publication protocol.

17. A method to provide redundant array of independent disks (RAID) functionality comprising:
detecting whether operation as a redundant array of independent disk (RAID) controller device is established;
establishing operation of a device as the RAID controller device when no device has established operation as the RAID controller device; and
publishing a block device before exposure as usable storage, wherein publication of the block device is understood only by the RAID controller device.

18. The method of claim 17, further including implementing an administration operation and an input/output (I/O) operation, wherein the device is device-specific to communicate with a specific type of device and all block devices associated with the specific type of device.

19. The method of claim 17, further including two or more instances of a device driver that are each to be deployed as an option ROM of a NVMe driver.

20. The method of claim 17, further including exposing the block device as useable storage in a RAID operation.

21. The method of claim 20, further including:
exposing a RAID volume using a public protocol that includes a path to a volume storage device corresponding to the block device; and
exposing a pass-through device using a public protocol that includes a path to the pass-through device where the block device is located.

22. The method of claim 17, further including:
using a private publication protocol to pass an input/output (I/O) request to one or more of a volume storage device or a pass-through device; and
managing a RAID schema.

23. The method of claim 17, further including:
installing the private control protocol to establish operation as the RAID controller device; and
publishing the block device using a private publication protocol, wherein publication using the private publication protocol is understood only by the RAID controller device.

24. The method of claim 23, further including:
identifying whether the private publication protocol is used to publish the block device; and
identifying the block device in response to identification of the private publication protocol.
